(19) United States
(12) Patent Application Publication
(10) Pub. No.: US 2005/0212184 A1
(43) Pub. Date: Sep. 29, 2005

(54) Method and device for producing a stamp

(76) Inventors: Franz Filzmoser, Thalheim bei Wels (AT); Ernst Faber, Wels (AT)

Correspondence Address: WILLIAM COLLARD;COLLARD & ROE, P.C., 1077 NORTHERN BOULEVARD, ROSLYN, NY, 11576, US

(21) Appl. No.: 10/521,215

(22) PCT Filed: Jul. 10, 2003
(86) PCT No.: PCT/AT03/00196

§ 371 Date: Jan. 13, 2005

(30) Foreign Application Priority Data
Jul. 22, 2002 (AT) A 1110/2002

(51) Int. Cl. B29C 43/22

(52) U.S. Cl. 264/509

(57) ABSTRACT

The invention relates to a method and a device for producing a stamp (1), a printing plate, or similar comprising a surface (3) that contains the printing pattern (2) and is produced by applying layers of a liquid and hardenable material (8) to a base. The aim of the invention is to create a production method by means of which stamps can be produced in a simple and inexpensive manner even in small quantities. Said aim is achieved by a printing device (4) comprising at least one printhead (5) which can be moved several times across the surface (3) of the stamp (1) and is provided with at least one nozzle (6) printing the surface (3) with layers of a liquid and hardenable material (8), for example a polymer.

The invention relates to a method and a device for producing a stamp, a printing plate or the like with a surface containing the printing pattern which is produced by applying a liquid and hardenable material in layers on a substrate.

The present invention relates to a stamp and printing plates or similar devices which serve to transmit a printing pattern to a body.

Usually, stamps or printing plates are made of various materials by material ablation, e.g. engraving, milling or the like. In modern tools, the material ablation is also effected by means of lasers which are guided over a block of plastics. The control data for the processing tool or the laser, respectively, required for obtaining the desired printing block are mostly provided by a computer.

As a rule, the material-ablating method for producing stamps, printing plates or the like require relatively great efforts for removing the ablated material. Moreover, material particles remaining on the stamp may cause imprecise and undesired printing results. Moreover, the dirt load caused by material-ablating production methods is relatively high, and therefore this equipment must be set up in a separate room or must at least be surrounded by a casing.

U.S. Pat. No. 5,731,033 A describes a means and a method for producing a stamp, wherein a liquid, hardenable material is applied by hand to the surface which contains the printing pattern. This manual production of a stamp is exclusively directed at a domestic use and is particularly well suited for children. However, a quick and simple production of stamps, as well as the production of very fine printing blocks with a high resolution is not possible.

Furthermore, methods for producing stamps are known, in which the stamp body is produced by sintering of a powderized material. DE 39 21 623 A1, e.g., describes such a method. Just like casting methods, this sintering method has the disadvantage of the comparatively complex and expensive production of the required mold that contains the respective printing pattern. Thus, such production methods are not suitable for small numbers of stamps or the like.

Finally, methods for producing stamps are known in which a liquid material is solidified by the directed irradiation with light, and the excess of material is removed e.g. by using ultrasonics. Such a method has been described in DE 197 47 877 A1, e.g. However, the handling of liquid stamping-surface blanks is complex, since the latter must not be exposed to light rays unintentionally.

Laser methods or photopolymer methods have advantages with regard to the residues forming, yet they are comparatively complex and expensive. A further disadvantage with the known production methods consists in the formation of undesired waste gases by the combustion of the plastics constituting the stamp or the like, and therefore it is often required to suck off the waste gases forming.

Also the production speed of known systems often constitutes a hindrance to a rapid production of printing blocks in particularly small quantities.

Therefore, the present invention has as its object to provide an above-mentioned method and an above-mentioned device for producing a stamp, a printing plate or the like, which allows for a particularly inexpensive, rapid and simple production of printing patterns also for a small number of pieces.

According to the invention, this object is achieved in terms of a method in that the application of the liquid and hardenable material in layers is carried out in print technology. By producing the stamp, the printing plate or the like in print technology, similar to the ink jet method, an ablation of material is not required, and hence devices for removing material residues and for sucking off vapors or the like that have formed are not required. Furthermore, devices for protecting the surroundings against contaminations are not required. In print technology, depending on the choice of the liquid and hardenable material and on the respective print head, comparatively high resolutions are attainable, so that also very fine printing blocks can be produced easily and rapidly. In order to obtain the relief-like structure forming the stamp, the printing plate or the like, several layers of the liquid and hardenable material are arranged one on top of the other. For this purpose, at least one print head with at least one nozzle is moved over a substrate, and the liquid and hardenable material is dispensed drop-wise. Dispensing is controlled via an appropriate valve according to the data of a computer. A further advantage consists in that with this method also particularly large stamps, printing plates or the like can be produced at relatively low costs. The substrate on which the surface comprising the printing pattern is applied can be removed after the printing procedure, or it may also remain.

Before the surface-forming material is applied, optionally a bonding agent layer can be applied on the substrate. The former serves for providing a connection between the printing block prepared in print technology, and the substrate. The material for the bonding agent must be adapted to the material of the substrate as well as to the material used for producing the printing pattern.

Prior to the printing procedure, additives may be admixed to the surface-forming material. The former may, e.g. serve to accelerate the hardening process or to form pores for so-called self-inking stamps. In this manner, two or more components of the liquid and hardenable material may be mixed shortly before the printing procedure.

To increase the viscosity of the surface-forming material, the latter may be heated before and/or during the printing procedure.

To allow for a particularly quick production of the stamp, the printing plate or the like, hardening of the surface-forming material may be accelerated between the layer-wise application thereof. This may, e.g., be effected by cooling or by spraying on of hardening agents or other chemical substances.

According to a further characteristic feature of the invention it is provided that the amount of the applied material can be metered. By metering the material, particularly fine details can be made in the printing block of the stamp, the printing plate or the like.

In case of a dosable amount of the applied material, the latter can also be reduced from layer to layer in order to achieve webs that taper in cross-section and to thereby allow for finer stamp images without risking that webs in the printing block might break.

Preferably, is a polymer or liquid caoutchouc is used as the surface-forming material.

To obtain so-called self-inking stamps, a porous material may be used as the surface-forming material. The ink diffuses through the forming pores when pressure is applied to the surface of the stamp, the printing plate or the like.

As the substrate, a glass plate may be used, which remains connected to the printing pattern when the production process has been finished, or from which the printing pattern is removed before it is arranged on the stamp, the printing plate or the like.

Likewise, it is possible to use a carrier film of plastics as said substrate which preferably remains on the stamp, the printing plate or the like when the production process has been finished.

The object according to the invention is also achieved by a device for producing a stamp, a printing plate or the like with a surface that contains the printing pattern, in which a printing device with at least one print head movable several times over the surface with at least one nozzle is provided for printing the surface in layers from a liquid and hardenable material. By the inventive use of the printing device, in particular of an inkjet-method like device for producing stamps, printing plates or the like, a particularly inexpensive and rapid production of stamps, printing plates or the like can be achieved also in small quantities. The movement of the print head in relationship to the surface of the stamp or of the printing plate can be achieved both, by movement of the print head and by movement of the substrate on which the printing pattern is to be built up, or by movement of both elements. Usually, the print head can be moved relative to the substrate in horizontal and vertical directions.

If the print head comprises a heating means, the surface-forming material can be heated and its viscosity can be increased before its ejection so that finer droplets of the material can be dispensed.

If a mixing means for mixing the surface-forming material is provided, a two- or multi-component material, which, for instance, hardens particularly quickly after having been mixed, may be used, on the one hand, or also other additives may be admixed to the material.

For accelerating the hardening procedure, a cooling means can be provided which preferably can be guided to follow the print head.

This cooling means may, e.g., be formed by a blower or the like, which will accelerate the hardening procedure of the material.

According to a further feature of the invention, a metering means is provided for metering the amount of material dispensed.

To activate the printing device for producing stamps, printing plates or the like, the former preferably comprises an interface for connection with a computer unit.

The present invention will be explained in more detail by way of the accompanying drawings which show an exemplary embodiment of the invention.

Therein,

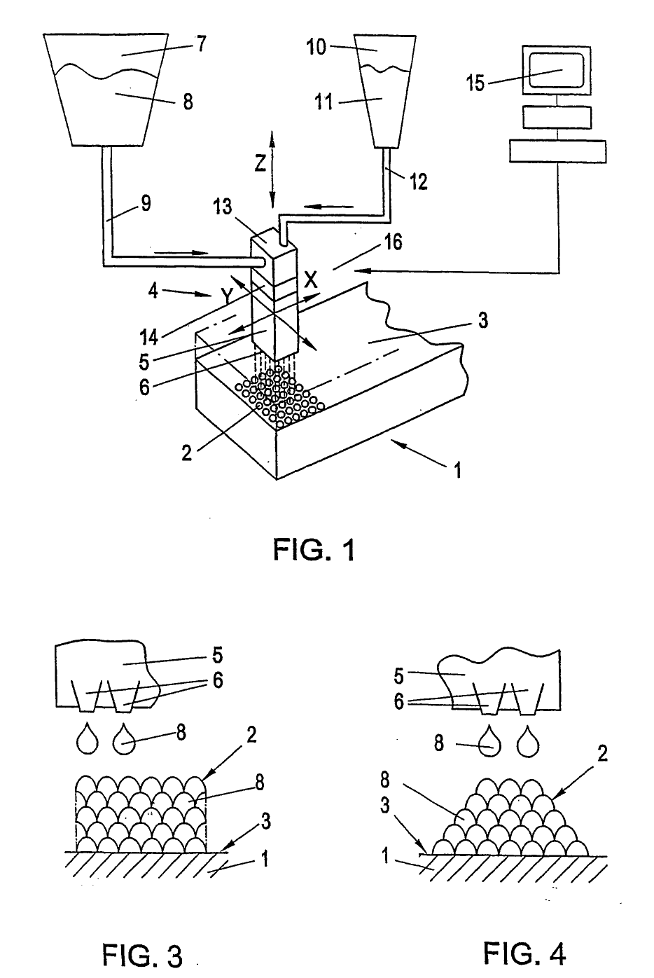

FIG. 1 shows a perspective schematic view of an inventive device for producing a stamp;

FIG. 2 shows a perspective view for illustrating a possible movement sequence of the print head;

FIG. 3 shows the sectional view of a part of the stamp surface produced according to the invention;

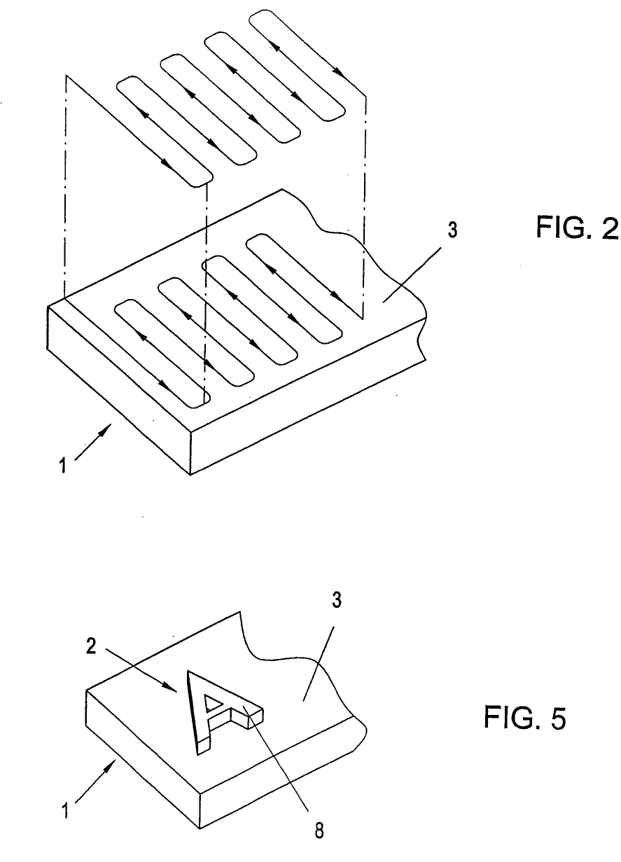

FIG. 4 shows a variant of a sectional view of a part of a stamp surface;

FIG. 5 shows a perspective view of a part of a stamp surface produced in print technology; and

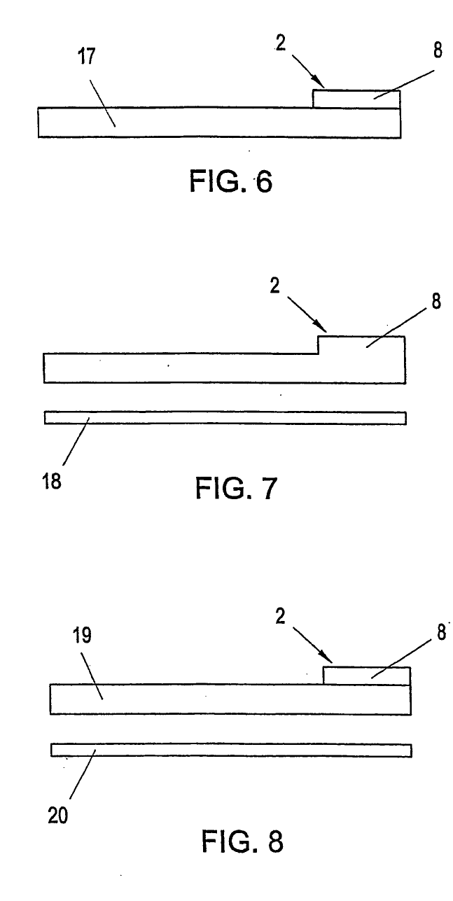

FIGS. 6 to 8 show sectional views of various embodiments of a stamp produced in print technology.

The device according to the invention for producing a stamp 1, a printing plate or the like with a surface 3 containing the printing pattern 2 comprises a printing device 4 with at least one print head 5 having at least one nozzle 6. The print head 5 is arranged to be movable over the surface 3, preferably in X-, Y- and Z-directions. Likewise, it is possible that the print head 5 stands still and the stamp 1, or the substrate, respectively, is moved accordingly. In a container 7, the material 8 forming the surface 3 of the stamp 1, the printing plate or the like, or at least a component of the material 8 is contained. Via an appropriate feed line 9, the liquid material 8 can be moved to the print head 5. Optionally, a component 11, or an additive, respectively, is stored in a further container 10, which component is supplied to the print head 5 via a feed line 12. The material 8 is mixed with the additive 11 in a mixing device 13 possibly present before it is ejected from the print head 5. To increase the viscosity of the material 8, the latter can be heated in a heating device 14 within or upstream of the print head 5. Usually the data necessary for controlling the delivery of the material in the print head 5 are delivered from a computer unit 15 which is connected to the printing device 4 via an interface 16.

The print head 5 moves over the surface 3 of the stamp 1 or the like, e.g. in meander-like fashion, as illustrated in FIG. 2. Wherever a relief is to be produced on the surface 3 of the stamp 1 according to the printing pattern 2 and as dictated by the data provided by the computer unit 15, the liquid and hardenable material 8 is delivered drop-wise via the nozzles 6 of the at least one print head 5.

As shown in the sectional representation according to FIG. 3, one layer each of the material 8 is built up on the surface 3 of the stamp 1 by the drop-wise delivery of the liquid, hardenable material 8. This procedure is repeated several times so that several layers of the material 8 are arranged one on top of the other, thus forming the printing pattern 2 of the stamp 1. In order to accelerate hardening of the liquid material 8 after its application on the surface 3 of the stamp 1, for instance a cooling of each layer of the material 8 can be effected after it has been applied. Moreover, as illustrated in FIG. 3, the print head 5 may be offset from layer to layer by a slight distance corresponding to approximately half the drop width so as to obtain an optimum layer composition.

According to FIG. 4, the width of the material 8 applied may be reduced from layer to layer, whereby finer stamp structures can be formed and, moreover, the stability of the forming webs of the printing pattern 2 can be increased.

FIG. 5 shows a perspective view of a stamp 1 produced according to the invention, in which the printing pattern 2 has been built on the surface 3 from the liquid and hardenable material 8 in print technology.

FIG. 6 shows a sectional view through a stamp 1, in which the material 8 forming the printing pattern 2 has been printed on a substrate in the form of a glass plate 17.

According to FIG. 7, the printing pattern 2 in combination with the substrate of the material 8 has been applied on a substrate in the form of a carrier plate 18. In this case, the carrier plate 18 remains on the stamp 1 or on the printing plate, respectively.

In the variant according to FIG. 8, the material 8 is printed on a work plate 19, which may, e.g., consist of a soft polymer. The work plate 19 is connected to a carrier film 20 which serves to reduce distortions of the printed image.

In order to produce several stamps 1 with the same printing pattern 2 in one working step, several print heads 5 may be interconnected and controlled by a computer unit 15. With the inventive method for producing stamps 1, printing plates or the like, it is possible to produce stamps 1 or the like also in small quantities in a simple, rapid and inexpensive manner. Moreover, dirt is not incurred in the method according to the invention, since in contrast to known production method, there is no ablation of material. Further processing, such as, e.g., sucking off of ablated material, or a subsequent cleaning of the stamp surface is not required. When using special materials for imprinting the stamp surfaces, also stamps with integrated ink pad, so-called self-inking stamps, can be produced. In such stamps, the ink will diffuse through pores of the stamp material to the surface thereof.

1-21. (canceled)

22. A method for producing a stamp or a printing plate with a surface containing the printing pattern which is produced by applying a liquid and hardenable material in layers on a substrate, wherein the application of the liquid and hardenable material in layers is carried out in print technology.

23. A method according to claim 22, wherein a bonding agent layer is applied on the substrate before the surface-forming material is applied.

24. A method according to claim 22, wherein additives are admixed to the surface-forming material prior to the printing procedure.

25. A method according to claim 22, wherein the surface-forming material is heated before and/or during the printing procedure.

26. A method according to claim 22, wherein hardening of the surface-forming material is accelerated between the layer-wise application thereof.

27. A method according to claim 26, wherein the hardening is accelerated by cooling.

28. A method according to claim 26, wherein the hardening is effected by spraying with hardening agents.

29. A method according to claim 22, wherein the amount of material applied can be metered.

30. A method according to claim 29, wherein the amount of material applied is reduced from layer to layer.

31. A method according to claim 22, wherein a polymer is used as the surface-forming material.

32. A method according to claim 22, wherein liquid caoutchouc is used as the surface-forming material.

33. A method according to claim 22, wherein a porous material is used as the surface-forming material.

34. A method according to claim 22, wherein a glass plate is used as substrate.

35. A method according to claim 22, wherein a carrier film of plastics is used as substrate.

36. A device for producing a stamp (1) or a printing plate, with a surface (3) containing the printing pattern (2), wherein a printing device (4) with at least one print head (5) movable several times over the surface (3) with at least one nozzle (6) is provided for printing the surface (3) in layers from a liquid and hardenable material (8) and a metering means being provided for metering the amount of material delivered.

37. A device according to claim 36, wherein the print head (5) comprises a heating means (14).

38. A device according to claim 36, wherein a mixing means (13) is provided for mixing the surface (3)-forming material (8).

39. A device according to claim 36, wherein a cooling means is provided which preferably can be guided to follow the print head (5).

40. A device according to claim 39, wherein the cooling means is formed by a blower.

41. A device according to claim 36, wherein the printing device (4) comprises an interface (16) for connection to a computing unit (15).
